(19) United States
(12) Patent Application Publication
(10) Pub. No.: US 2024/0184164 A1
(43) Pub. Date: Jun. 6, 2024

(54) DISPLAY MODULE

(71) Applicant: Chung-Ming Hu, Tainan City (TW)

(72) Inventor: Chung-Ming Hu, Tainan City (TW)

(21) Appl. No.: 18/504,174

(22) Filed: Nov. 8, 2023

(30) Foreign Application Priority Data
Dec. 1, 2022 (TW) 111146072

(51) Int. Cl. G02F 1/1335; G02F 1/1343

(52) U.S. Cl. CPC G02F 1/133533; G02F 1/133521; G02F 1/134363; G02F 2203/01

(57) ABSTRACT

A display module including a display panel and an image color switch film is provided. The image color switch film is disposed above or below the display panel. In a viewing angle at least in a range of 45 degrees to 85 degrees, a peak of a transmittance spectrum of the image color switch film falls within a range of 400 nanometers (nm) to 600 nm, and an average transmittance of the transmittance spectrum within a range of 450 nm to 600 nm is greater than an average transmittance of the transmittance spectrum within a range of 650 nm to 800 nm.

### CROSS-REFERENCE TO RELATED APPLICATION

This application claims the priority benefit of Taiwan application serial no. 111146072, filed on Dec. 1, 2022. The entirety of the above-mentioned patent application is hereby incorporated by reference herein and made a part of this specification.

### BACKGROUND

### Technical Field

The disclosure relates to a display module, and in particular to a display module.

### Description of Related Art

In the operation of liquid crystal displays, although in the use of vertical alignment (VA) or in-plane switching (IPS) and other wide viewing angle technologies, materials such as a compensation film or a retardation film are used to compensate for the color shift of a large viewing angle, but perfect compensation cannot be achieved due to different signal emergence angles. Although the color of a large viewing angle has been partially corrected by the compensation film or the retardation film, there are still color signal shifts of different degrees.

The in-plane switching liquid crystal display (IPS LCD) is considered to be a liquid crystal mode that is less prone to the color shift in liquid crystal display technology. However, in fact, the in-plane switching liquid crystal display still has the following two problems: First, in the dark state, there is insufficient contrast in the image screen of a front viewing angle and a large viewing angle; second, in the bright state, the image screen of a large viewing angle tends to be yellowish and orange, so the performance of the blue screen is not good.

In the in-plane switching liquid crystal display technology, although the compensation film or the retardation film is used to compensate for the color shift of a large viewing angle, the image signal cannot be perfectly compensated due to the limitation of display technology (that is, liquid crystal adopts horizontal alignment). Although the problem of the in-plane switching liquid crystal display being too bright at various viewing angles in the dark state is compensated by the compensation film, the in-plane switching liquid crystal display still cannot compete with the vertical alignment liquid crystal display in the contrast part, and the image quality performance is still lacking. However, due to the advantage of low degree of the color shift in a large viewing angle, the in-plane switching liquid crystal display may become a more superior display technology if the characteristics of contrast and large viewing angle performance can be improved.

### SUMMARY

The disclosure provides a display module, which can effectively improve the contrast of various viewing angles, and can strengthen the blue light band and suppress the red light band in the image screen of a large viewing angle, thereby improving the shortcomings of yellowish and orange-red image screens of large viewing angles.

An embodiment of the disclosure provides a display module, including a display panel and an image color switch film. The image color switch film is disposed above or below the display panel. In a viewing angle at least in a range of 45 degrees to 85 degrees, a peak of a transmittance spectrum of the image color switch film falls within a range of 400 nanometers (nm) to 600 nm, and an average transmittance of the transmittance spectrum within a range of 450 nm to 600 nm is greater than an average transmittance of the transmittance spectrum within a range of 650 nm to 800 nm.

An embodiment of the disclosure provides a display module, including a display panel and an image color switch film. The image color switch film is disposed above or below the display panel. Under a front viewing angle, a peak of a transmittance spectrum of the image color switch film falls within a range of 400 nm to 600 nm, and an average transmittance of the transmittance spectrum within a range of 500 nm to 600 nm is greater than an average transmittance of the transmittance spectrum within a range of 650 nm to 800 nm.

In the display module of the embodiment of the disclosure, the image color switch film is used, and in the viewing angle at least in the range of 45 degrees to 85 degrees, the peak of the transmittance spectrum falls within the range of 400 nm to 600 nm, or under the front viewing angle, the peak of transmittance spectrum falls within the range of 400 nm to 600 nm, so that the image color switch film may treat different colors of light from the display panel differently. Therefore, the display module of the embodiment of the disclosure can effectively improve the contrast of various viewing angles, and in the image screen of a large viewing angle, can strengthen the blue light band and suppress the red light band or the visible light band with a wavelength greater than or equal to 580 nm, thereby improving the shortcomings of yellowish and orange-red image screens of large viewing angles.

### BRIEF DESCRIPTION OF THE DRAWINGS

FIG. 1A is a schematic cross-sectional view of a display module according to an embodiment of the disclosure.

FIG. 1B is a three-dimensional layered view of the display module shown in FIG. 1A.

FIG. 1C is a three-dimensional schematic diagram of parallel polarized light and vertically polarized light of the display module shown in FIG. 1B.

FIG. 2 is a transmittance spectrum diagram of the image color switch film of FIG. 1A when the viewing angle is 60 degrees and a transmittance spectrum diagram without the image color switch film when the viewing angle is 60 degrees.

FIG. 3A is a spectrum of the display panel in FIG. 1A at viewing angles of 0 degrees, 45 degrees, and 60 degrees in a dark state.

FIG. 3B is a spectrum of the display panel in FIG. 1A at viewing angles of 0 degrees, 45 degrees, and 60 degrees in a bright state.

FIG. 4A is a curve diagram of dark-state luminance variation rates at various viewing angles for the two embodiments of FIG. 2 and when there is no image color switch film.

FIG. 4B shows contrast enhancement rates at various viewing angles of the two embodiments of FIG. 4A and when there is no image color switch film.

FIG. 5A is a transmittance spectrum diagram of two embodiments of the image color switch film of FIG. 2 at the viewing angle of 0 degrees and a transmittance spectrum diagram of no image color switch film at the viewing angle of 0 degrees.

FIG. 5B is a curve diagram of bright-state luminance variation rates at various viewing angles for the two embodiments of FIG. 5A and when there is no image color switch film.

FIG. 6 is a schematic cross-sectional view of a display module according to another embodiment of the disclosure.

FIG. 7 is a schematic cross-sectional view of a display module according to yet another embodiment of the disclosure.

FIG. 8 is a schematic cross-sectional view of a display module according to still another embodiment of the disclosure.

FIG. 9 is a schematic cross-sectional view of a display module according to another embodiment of the disclosure.

FIG. 10A is a schematic cross-sectional view of a display module according to yet another embodiment of the disclosure.

FIG. 10B is a three-dimensional layered view of the display module shown in FIG. 10A.

FIG. 11 is a three-dimensional layered view of a display module according to still another embodiment of the disclosure.

FIG. 12 is a schematic cross-sectional view of a display module according to another embodiment of the disclosure.

FIG. 13 is a schematic cross-sectional view of a display module according to yet another embodiment of the disclosure.

FIG. 14A is a schematic cross-sectional view of a display module according to still another embodiment of the disclosure.

FIG. 14B is a line chart of dark-state luminance retention rates and bright-state luminance retention rates at various viewing angles of the display module using the image color switch film in FIG. 14A.

FIG. 15A is a schematic cross-sectional view of a display module according to another embodiment of the disclosure.

FIG. 15B is a line chart of dark-state luminance retention rates and bright-state luminance retention rates at various viewing angles of the display module using the image color switch film in FIG. 15A.

FIG. 16 is a transmittance spectrum diagram of the image color switch film of FIG. 1A, FIG. 14A or FIG. 15A when the viewing angle is 0 degrees and a transmittance spectrum diagram without the image color switch film when the viewing angle is 0 degrees.

### DESCRIPTION OF THE EMBODIMENTS

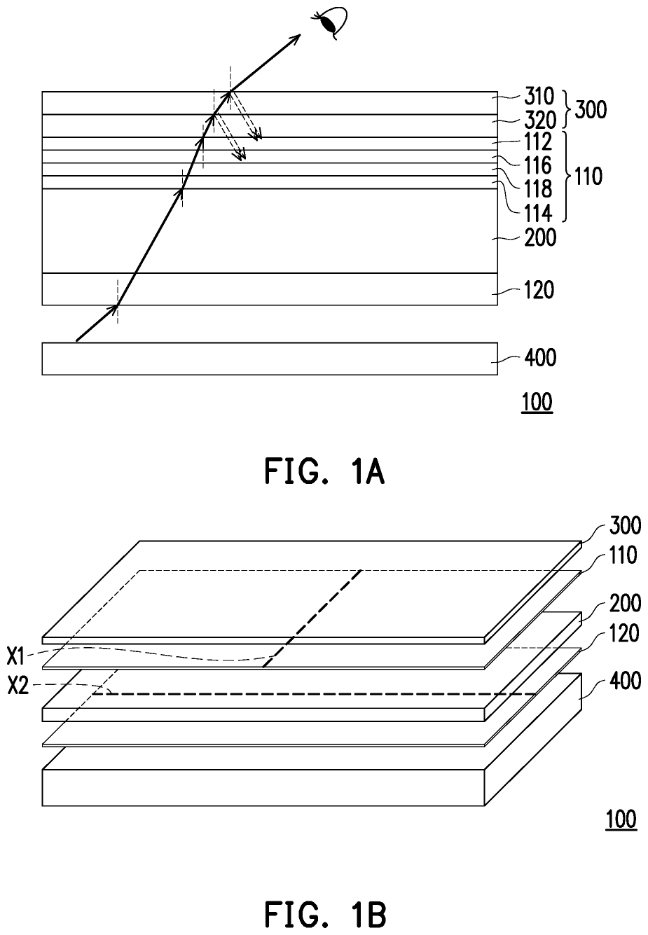

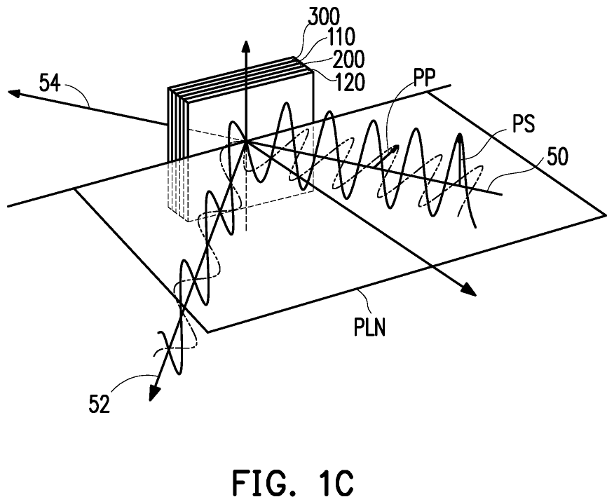

FIG. 1A is a schematic cross-sectional view of a display module according to an embodiment of the disclosure. FIG. 1B is a three-dimensional layered view of the display module in FIG. 1A. FIG. 1C is a perspective schematic diagram of parallel polarized light and vertical polarized light of the display module in FIG. 1B. Please refer to FIGS. 1A and 1B first. A display module 100 of the embodiment includes a display panel 200 and an image color switch film 300. In the embodiment, the display panel 200 is a liquid crystal display panel, such as an in-plane switching liquid crystal display panel. However, in other embodiments, the display panel 200 may also be a vertical alignment liquid crystal display panel (VA-LCD panel) or a liquid crystal display panel of other liquid crystal modes. Alternatively, in other embodiments, the display panel 200 may also be an organic light emitting diode display panel, a micro light emitting diode display panel or other suitable display panels. The image color switch film 300 is disposed above or below the display panel 200, and FIG. 1A takes the configuration above the display panel 200 as an example.

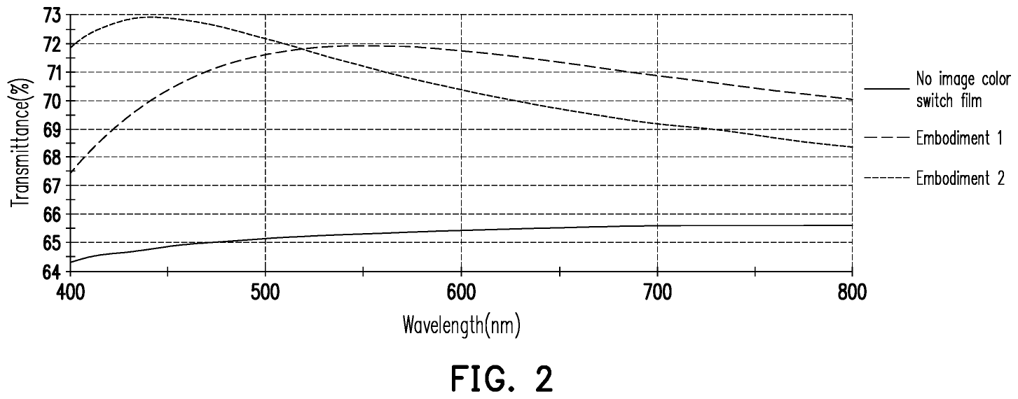

FIG. 2 is a transmittance spectrum diagram of the image color switch film of FIG. 1A when the viewing angle is 60 degrees and a transmittance spectrum diagram without the image color switch film when the viewing angle is 60 degrees. Referring to FIGS. 1A and 2, in an embodiment, in a viewing angle at least in a range of 45 degrees to 85 degrees (or in an embodiment, when the viewing angle is greater than 0 degrees to less than or equal to 88 degrees), a peak of a transmittance spectrum of the image color switch film 300 falls within a range of 400 nanometers (nm) to 600 nm, and an average transmittance of the transmittance spectrum within a range of 450 nm to 600 nm is greater than an average transmittance of the transmittance spectrum within a range of 650 nm to 800 nm, as shown in the curves of Embodiment 1 and Embodiment 2 in FIG. 2. The above-mentioned viewing angle refers to an included angle between a line of sight and a normal direction of the image color switch film 300 or the display panel 200, which is, for example, the viewing angle in the horizontal direction of the display panel 200, but may also be the viewing angle in the vertical direction of the display panel 200 in another embodiment. In Embodiment 1 and Embodiment 2 in FIG. 2, the average transmittance of the above-mentioned transmittance spectrum within the range of 450 nm to 600 nm is greater than the average transmittance of the transmittance spectrum within the range of at 650 nm to 800 nm. In addition, in Embodiment 1 of FIG. 2, the spectral intensity of the transmittance spectrum increases from a short wavelength end of the transmittance spectrum (i.e., the left end of FIG. 2) to the above-mentioned peak, and decreases from the above-mentioned peak to a long wavelength end of the transmittance spectrum.

Referring to FIG. 1A again, the image color switch film 300 includes at least one layer of interference thin film, which uses the principle of thin film interference to reflect light of different wavelengths (i.e., red light, green light, and blue light) to different degrees, and be penetrated by the light of different wavelengths. In the embodiment, the at least one layer of interference thin film includes a first light-transmitting film 310 and a second light-transmitting film 320. The second light-transmitting film 320 is stacked with the first light-transmitting film 310, in which the refractive index of the first light-transmitting film 310 is smaller than the refractive index of the second light-transmitting film 320. In an embodiment, the refractive index of the first light-transmitting film 310 is 1.6 or less, for example, 1.2 to 1.6, and the refractive index of the second light-transmitting film 320 is 1.7 to 2.4. In the embodiment, the display module 100 further includes a polarizing plate 110, disposed between the image color switch film 300 and the display panel 200. In addition, in the embodiment, the second light-transmitting film 320 is disposed between the first light-transmitting film 310 and the polarizing plate 110, and the refractive index of the first light-transmitting film 310 is, for example, 1.66 or less. In addition, the display module 100 may further include a polarizing plate 120, in which the display panel 200 is disposed between the polarizing plate 110 and the polarizing plate 120.

In the embodiment, the material of the first light-transmitting film 310 is, for example, silicon dioxide (SiO₂), magnesium fluoride (MgF2) or a coating type low refractive index material, and the material of the second light-transmitting film 320 may be a high refractive index transparent ceramic material or a coating type high refractive index coating, such as titanium dioxide, niobium pentoxide (Nb2O5) or indium tin oxide (ITO).

In the embodiment, the polarizing plate 110 includes a first transparent substrate 112, a second transparent substrate 114, a polarizing layer 116, and a retardation compensation film 118. The first transparent substrate 112 is disposed between the image color switch film 300 and the display panel 200, and the second transparent substrate 114 is disposed between the first transparent substrate 112 and the display panel 200. The polarizing layer 116 is disposed between the first transparent substrate 112 and the second transparent substrate 114, and the retardation compensation film 118 is disposed between the first transparent substrate 112 and the second transparent substrate 114. In the embodiment, the retardation compensation film 118 is disposed between the polarizing layer 116 and the second transparent substrate 114. In another embodiment, the retardation compensation film 118 and the second transparent substrate 114 may be integrated, that is, the second transparent substrate 114 is a retardation compensation film, and the polarizing plate 110 may not be provided with an additional retardation compensation film 118. Specifically, the second transparent substrate 114 may become a retardation compensation film through a stretching process. Alternatively, a liquid crystal layer (i.e., a retardation compensation film 118) may be coated on the second transparent substrate 114. Alternatively, a liquid crystal layer may also be coated on the stretched second transparent substrate 114, that is, both the second transparent substrate 114 and the retardation compensation film 118 have the function of retardation compensation. The retardation compensation film 118 and the stretched second transparent substrate 114 may have birefringence or multi-refringence, that is, have different refractive indices in different directions. Therefore, the phase difference of the large viewing angle of image light emitted from the display panel 200 may be compensated, so that the image quality of the large viewing angle may be improved. The retardation compensation film 118 may adopt various techniques well known to those skilled in the art, and the descriptions are not repeated here.

In addition, the polarizing plate 120 may be a general polarizing plate, which may include two transparent substrates and a polarizing layer disposed between the two transparent substrates. A backlight module 400 commonly used in a liquid crystal display may be provided under the polarizing plate 120, that is, the polarizing plate 120 is attached to the bottom of the display panel 200 (such as a liquid crystal display panel), and the polarizing plate 120 is located above the backlight module 400. This is well known to those skilled in the art and is not to be repeat here. In addition, the image color switch film 300 is not limited to include only the first light-transmitting film 310 and the second light-transmitting film 320. In another embodiment, the image color switch film 300 may include three or more light-transmitting films with high and low refractive indices stacked alternately, and the disclosure is not limited thereto. Alternatively, in another embodiment, the image color switch film 300 may be a single light-transmitting film with a refractive index greater than 1.66. In an embodiment, the refractive index of the single light-transmitting film (i.e., the image color switch film 300) may be 2 to 2.1.

In the embodiment, the materials of the first transparent substrate 112 and the second transparent substrate 114 are, for example, polyester (PET), tri-acetyl cellulose (TAC), polymethyl methacrylate (PMMA) or other plastic substrates, and the material of the polarizing layer 116 is, for example, polyvinyl alcohol (PVA), but the disclosure is not limited thereto.

For the image color switch film 300 of Embodiment 1, the long-wavelength red light from the display panel 200 is reflected to the inside of the display module 100 by thin-film interference when viewed both from the front and at a large viewing angle, so as to cut off the peripheral light leakage of the red light part in the dark state to enhance contrast. For the image color switch film 300 of Embodiment 2, in the case of a large viewing angle (such as a viewing angle of 30 degrees to 75 degrees), the transmittance of blue light is particularly enhanced to reduce the phenomenon that the in-plane switching liquid crystal display panel tends to be orange-red, and make the blue screen more clear and vivid. Among them, Embodiment 1 may enhance the contrast of the large viewing angle, and Embodiment 2 may enhance the blue color performance of the large viewing angle. In an embodiment, the target spectrum is designed based on the transmittance design of D65 white light so that the peak position may be placed at a position to the left of 600 nanometer (nm) (i.e., less than 600 nm).

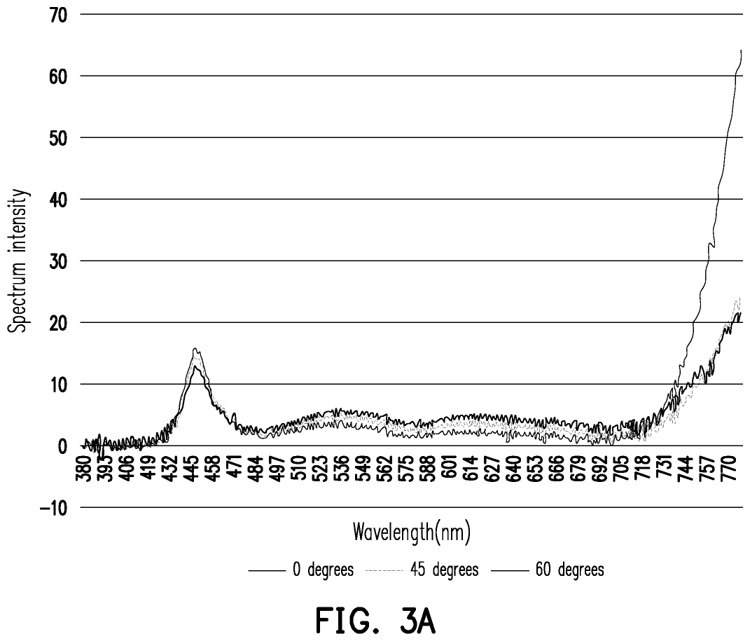

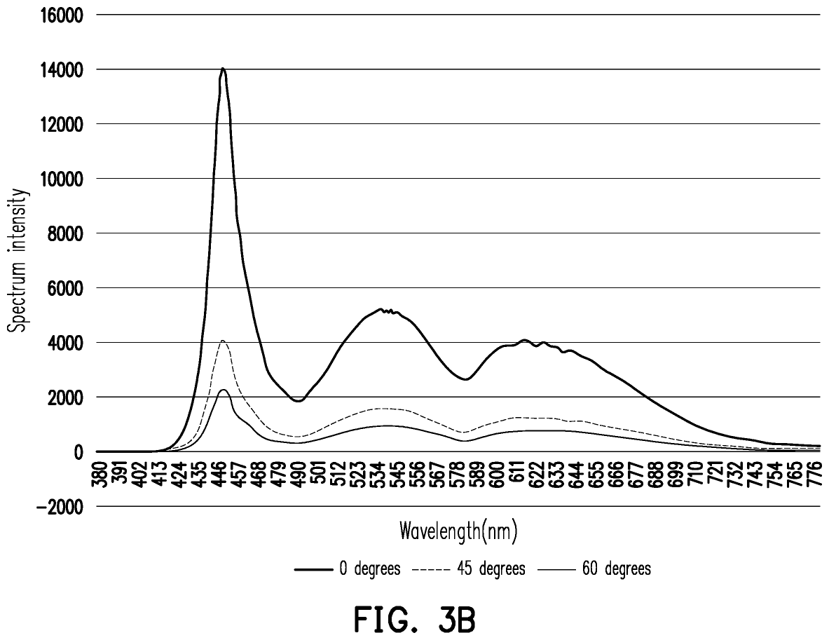

FIG. 3A is a spectrum of the display panel in FIG. 1A at viewing angles of 0 degrees, 45 degrees, and 60 degrees in the dark state, and FIG. 3B is a spectrum of the display panel in FIG. 1A at viewing angles of 0 degrees, 45 degrees, and 60 degrees in the bright state. Please refer to FIGS. 1A, 3A, and 3B. The main problem of the display panel 200 (i.e., in-plane switching liquid crystal display panel) is that in the dark state, the energy of the red light wave band increases (the tail section is upturned, referring to the spectrum greater than 700 nm). In addition, in the dark state, the energy of the green light at the viewing angles of 45 degrees and 60 degrees increases, resulting in an increase in the brightness of the dark state and a decrease in contrast at the large viewing angle. In addition, in the bright state, comparing the area under the spectral curve, it may be seen that the proportion of blue light energy at the large viewing angle decreases, resulting in an orange-red screen. Table 1 below lists the proportions of blue light, green light, and red light at different viewing angles.

TABLE 1

| Viewing | Blue | Green | Red l |
|---|---|---|---|
| angle | light | light | ight |
| 0 degrees | 32.4% | 30.5% | 37.1% |
| 45 degrees | 30.9% | 30.6% | 38.5% |
| 60 degrees | 29.5% | 30.4% | 40.1% |

The image color switch film 300 may use the multi-layer film design to enhance the blue light wave band and suppress the red light at the large viewing angle to achieve an improved contrast effect. After the contrast of each viewing angle is improved, the image quality is more advantageous, and the color rendering is more saturated and clear. The means of improvement are as follows:

In the case of the front viewing angle, part of the blue light (such as light with a wavelength at 450 nm or below) may be cut off, and the most important thing is to cut off the red light in the long-wavelength wave band. In addition, comparing the spectrum of the in-plane switching liquid crystal display panel in the bright state and the dark state, it may be found that in the dark state, there are protrusions in the long-wavelength wave band of red light (such as red light with a wavelength greater than 700 nm), and the image color switch film 300 is to use the destructive interference method suppresses the protrusion of the red light wave band, which may effectively reduce the brightness of the dark state to improve the contrast of each viewing angle. On the other hand, the blue light wave band also has a higher protrusion, especially at the front viewing angle, so it may also be considered to suppress the wave band at 450 nm and below, which may reduce the brightness of the dark state without greatly affecting the brightness. The advantages of the above approach are as follows: In terms of brightness specifications, the loss is only within 0% to 10% (for the front viewing angle), and in the case of an effective match with the display panel 200, there is no loss even at the front viewing angle, and the brightness of the large viewing angle is improved. In terms of contrast specifications, because only part of the light energy with wavelengths 450 nm and below and 700 nm and above is reduced, the brightness in the dark state may be reduced, thereby improving the contrast and enhancing the image quality of the in-plane switching liquid crystal display panel.

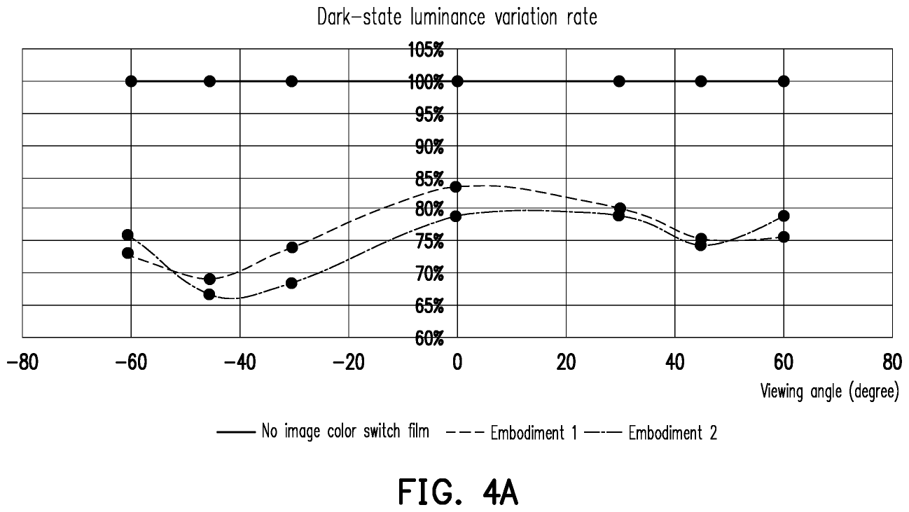

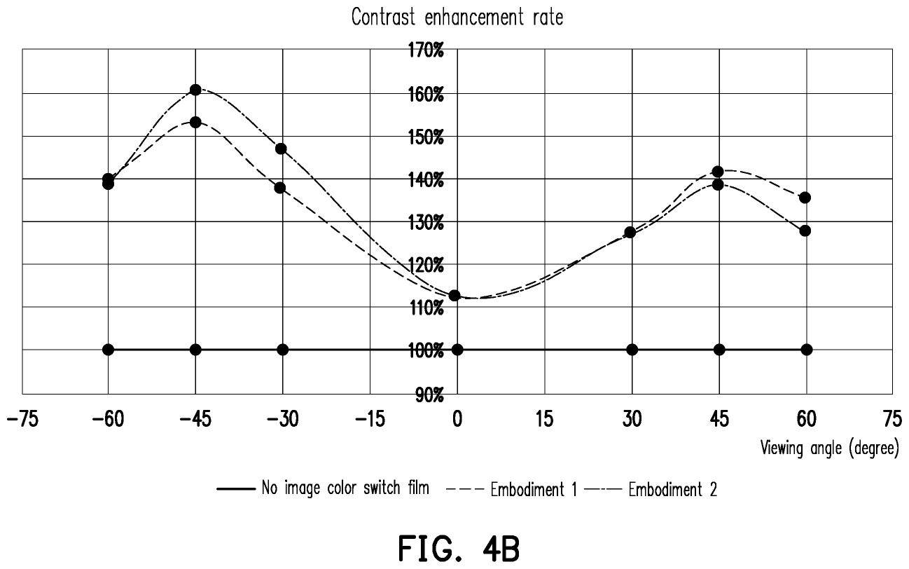

FIG. 4A is a curve diagram of dark-state luminance variation rates at various viewing angles for the two embodiments of FIG. 2 and when there is no image color switch film. FIG. 4B shows contrast enhancement rates at various viewing angles of the two embodiments of FIG. 4A and when there is no image color switch film. Please refer to FIGS. 1A, 3A, and 2, and FIGS. 4A to 4B. FIG. 2 shows two embodiments (i.e., Embodiment 1 and Embodiment 2) of the design concept of the image color switch film 300. With the multi-layer film solution of the image color switch film 300, at a large viewing angle of 45 degrees (or above), design may be made with this concept: the peak is set between blue light and green light (such as the range of 450 nm to 550 nm in the visible spectrum), so the tail of the design spectrum is relatively suppressed, and the blue light and part of the green light are strengthened. Therefore, the phenomenon that the in-plane switching liquid crystal display panel turns yellowish and orange at a large viewing angle is more balanced due to the strengthened blue light signal. In addition, the two different embodiments represent different capabilities of suppressing red light and enhancing blue light signals, and the selection needs to be matched with native in-plane switching liquid crystal display panels.

FIG. 3A represents the dark state spectrum of a native in-plane switching liquid crystal display module. Generally speaking, if the contrast is to be improved, the main principle is to suppress the light leakage in the dark state. In the in-plane switching liquid crystal display mode, the red light and the blue light need to be suppressed in the dark state, and there is an opportunity to improve the contrast.

The dark-state luminance variation rates of Embodiments 1 and 2 in FIG. 4A are relative to the dark-state luminance of the native in-plane switching liquid crystal display module without the image color switch film 300, so the dark-state luminance variation rates of the native in-plane switching liquid crystal display module without the image color switch film 300 is set to 100% at various viewing angles. In FIG. 4A, after using the image color switch film 300, there is an opportunity to suppress the light leakage in the dark state at various viewing angles, and the light leakage may be reduced by about 30% when the viewing angle is 45 degrees left and right.

The contrast enhancement rates of Embodiments 1 and 2 in FIG. 4B are relative to the contrast of the native in-plane switching liquid crystal display module without the image color switch film 300, so the contrast enhancement rates of the native in-plane switching liquid crystal display module without the image color switch film 300 is set to 100% at various viewing angles. It can be seen from FIG. 4B that when the light leakage in the dark state is suppressed, the contrast is also improved. Different designs have different effects on contrast enhancement. In the design of the image color switch film 300, the design is not only aimed at the viewing angle of 45 degrees, but also may improve the contrast of other different viewing angles through the red shift phenomenon. In addition, different surface treatments of polarizing plates also result in different degrees of contrast improvement. In Embodiment 1 and Embodiment 2, the viewing angle of 45 degrees improves the contrast the most, but the design may also be made according to the viewing angle of 60 degrees or larger.

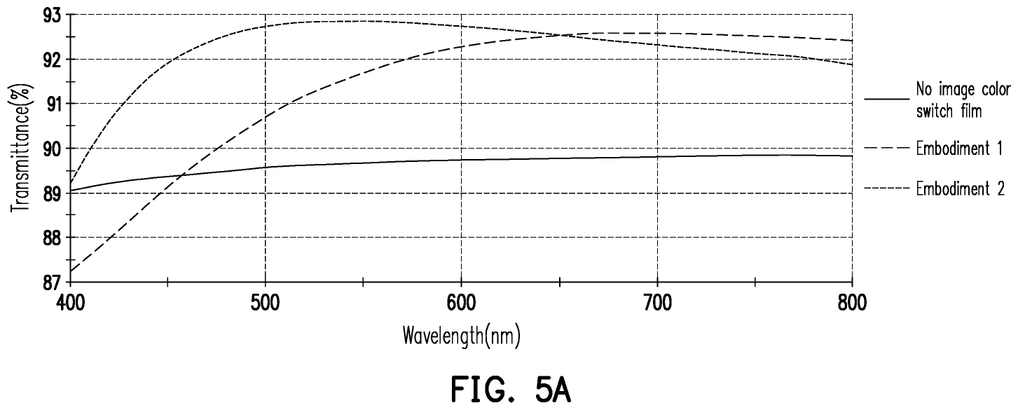

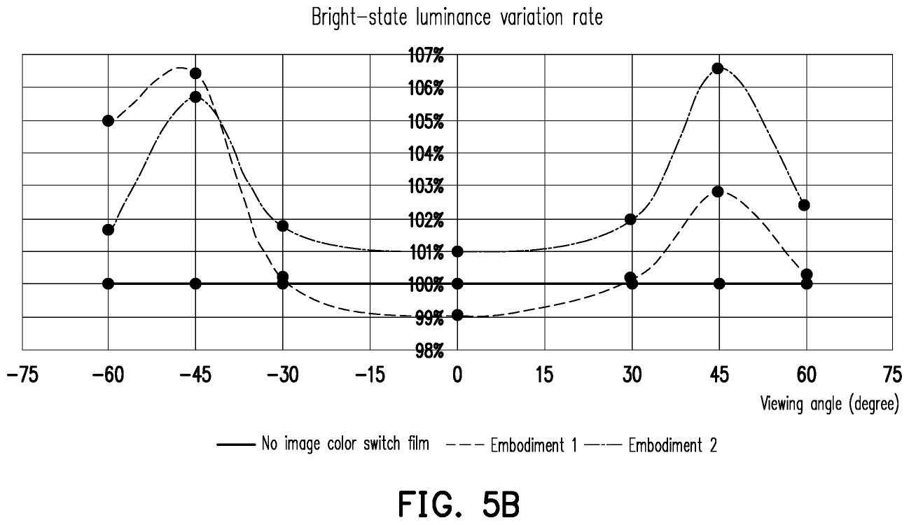

FIG. 5A is a transmittance spectrum diagram of two embodiments of the image color switch film of FIG. 2 at the viewing angle of 0 degrees and a transmittance spectrum diagram of no image color switch film at the viewing angle of 0 degrees. FIG. 5B is a curve diagram of bright-state luminance variation rates at various viewing angles for the two embodiments of FIG. 5A and when there is no image color switch film. Please refer to FIGS. 1A, 5A, and 5B. In terms of design, in order to avoid affecting the transmittance of the front viewing angle, it can be considered that the transmittance spectrum within a range of 450 nm to 550 nm should not be greatly reduced when the viewing angle is 0 degrees (as shown in FIG. 5A) to avoid the decrease in the transmittance. As shown in FIG. 5A, Embodiment 2 still has a higher transmittance spectrum within the range of 450 nm to 550 nm. Therefore, in terms of brightness in the bright state, Embodiment 2 has higher transmittance than the native in-plane switching liquid crystal display module without the image color switch film 300. Moreover, the bright-state luminance variation rate of Embodiments 1 and 2 in FIG. 5B is relative to the bright-state luminance of the native in-plane switching liquid crystal display module without the image color switch film 300, so the bright-state brightness variation rate of the native in-plane switching liquid crystal display module without the image color switch film 300 is set to 100% at various viewing angles.

In addition, in order to ensure that the interference effect can occur, if a single-layer film is taken as an example, a thickness of the formed thin film is d, a refractive index is n, and a viewing angle is 0, then n·d·cos θ=¼·m·λ, where m is an odd number, λ is the wavelength of light, and the specific definition of θ is an included angle between a line connecting the user's eye position to the center of the light emitting surface of the display module and the normal line of the display module.

Please refer to FIGS. 1B and 1C again. In the embodiment, a transmission axis X1 of the polarizing plate 110 is parallel to the short side direction of the display panel 200, a transmission axis X2 of the polarizing plate 120 is, for example, parallel to the long side direction of the display panel 200, and the transmission axis X1 and the transmission axis X2 are perpendicular to each other (as shown in FIG. 1B). If the transmission axis X1 of the polarizing plate 110 is perpendicular to the long side direction of the display panel 200 (the long side direction is, for example, parallel to the desktop direction), vertically polarized light may be observed at the large viewing angle in the horizontal direction of the display module 100. Moreover, if viewed from a plane PLN formed by incident light 50 and reflected light 52 from the backlight module 400, only polarized light that may meet the transmission axis X1 of the polarizing plate 110 and whose polarization direction PS is perpendicular to the plane PLN (i.e., vertically polarized light) may pass through (as shown in FIG. 1C). Therefore, in terms of interference design, the parameters of the image color switch film 300 (such as film thickness, a refractive index, etc.) may be designed for vertically polarized light, that is, the design is tailored for vertically polarized light and the spectrum of the vertically polarized light may be adjusted in the above-mentioned manner, so that the vertically polarized light has the above-mentioned optical properties. Moreover, a part of the incident light 50 passes through the polarizing plate 120, the display panel 200, the polarizing plate 110, and the image color switch film 300 to become transmitted light 54, and a part of the incident light 50 is reflected by the image color switch film 300 to become reflected light 52. However, in another embodiment, the image color switch film 300 is located above the polarizing plate 120. If the transmission axis X2 is parallel to the short side direction of the display panel 200 (the short side direction is perpendicular to the desktop), after entering the display panel 200 from the backlight module 400, the incident light 50 hits the image color switch film 300 and generates the reflected light 52. The incident light 50 and the reflected light 52 form the plane PLN, and most of the polarized light whose polarization direction PS is perpendicular to the plane PLN may penetrate the transmission axis X2, and the image color switch film 300 is also designed with the vertical polarization direction PS. Conversely, if the direction of the transmission axis X2 is parallel to the long side direction of the display panel 200 and the image color switch film 300 is located above the polarizing plate 120, similarly, a parallel polarization direction PP is used for the image adjustment of the horizontal large viewing angle image (in which the parallel polarization direction PP is parallel to the plane PLN, and the polarized light whose polarization direction PP is parallel to the plane PLN is called parallel polarization light). Generally speaking, design is facilitated when the parameters of the image color switch film 300 are designed according to the vertically polarized light, and the above-mentioned good optical properties may be achieved with less number of film layers.

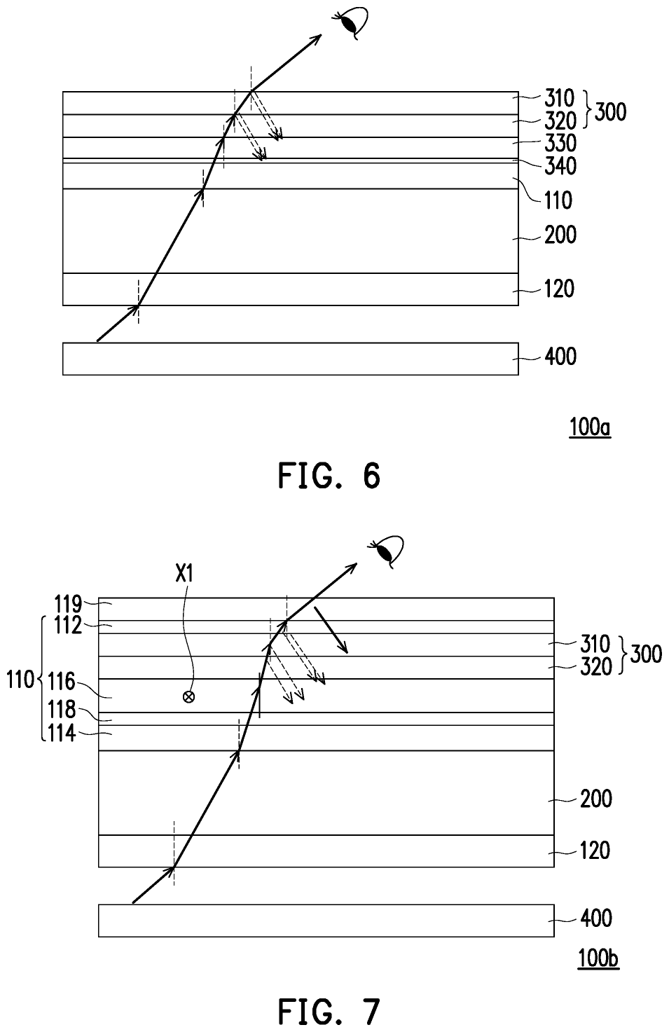

FIG. 6 is a schematic cross-sectional view of a display module according to another embodiment of the disclosure. A display module 100a of the embodiment is similar to the display module 100 shown in FIG. 1A, and the difference between the two is that in the display module 100 shown in FIG. 1A, the first light-transmitting film 310 and the second light-transmitting film 320 are formed on the polarizing plate 110. However, in the display module 100a of the embodiment, the first light-transmitting film 310 and the second light-transmitting film 320 of the image color switch film 300 are formed on a light-transmitting substrate 330 first, and then the light-transmitting substrate 330 is further pasted on the polarizing plate 110 through an adhesive material 340.

FIG. 7 is a schematic cross-sectional view of a display module according to yet another embodiment of the disclosure. Referring to FIG. 7, a display module 100b of the embodiment is similar to the display module 100 of FIG. 1A, and the differences between the two are as follows. In the display module 100 of FIG. 1A, the image color switch film 300 is disposed outside the polarizing plate 110. However, in the display module 100b of the embodiment, the image color switch film 300 may be integrated inside the polarizing 110. Specifically, in the embodiment, the image color switch film 300 is disposed between the first transparent substrate 112 and the display panel 200, the second transparent substrate 114 is disposed between the image color switch film 300 and the display panel 200, the polarizing layer 116 is disposed between the image color switch film 300 and the second transparent substrate 114, and the retardation compensation film 118 is disposed between the polarizing layer 116 and the second transparent substrate 114.

In the embodiment, the order of the first light-transmitting film 310 and the second light-transmitting film 320 of the image color switch film 300 may be reversed. The first light-transmitting film 310 may be below the second light-transmitting film, or the second light-transmitting film 320 may be below the first light-transmitting film 310.

The refractive index of the first light-transmitting film 310 is 1.6 or below, and the refractive index of the second light-transmitting film 320 is 1.8 to 2.5. In the embodiment, the refractive index of the first transparent substrate 112 is lower than 1.7.

In the embodiment, the display module 100b further includes a surface treatment layer 119, and the first transparent substrate 112 is disposed between the surface treatment layer 119 and the image color switch film 300. For example, the refractive index of the surface treatment layer 119 is lower than 1.55. The surface treatment layer 119 is, for example, an anti-glare layer, an anti-reflection layer or a hard-coating layer.

In addition, the same as the embodiment of FIG. 1A is that the retardation compensation film 118 and the second transparent substrate 114 may be integrated, that is, the second transparent substrate 114 is a retardation compensation film, and an additional retardation compensation film 118 may not be provided in the polarizing plate 110.

In the embodiment, the transmission axis X1 of the polarizing layer 116 is, for example, parallel to the short side direction of the display panel 200 (i.e., the direction entering the paper surface of FIG. 7). Therefore, when looking at the display module 100b at the large viewing angle in the horizontal direction, the user's eyes see vertically polarized light. If the incident light 50 and the reflected light 52 with a large viewing angle are set as the plane PLN (please refer to FIG. 1C), limited by the transmission axis X1 of the polarizing plate 110 of the display module 100b being parallel to the short side direction of the display module 100b, in the incident light 50, only the polarized light whose polarization direction PS is parallel to the short side direction may mostly pass through the display panel 200. Therefore, the image color switch film 300 may be designed according to the direction of the transmission axis X1 of the polarizing plate 110 to achieve the above-mentioned optical properties. However, in other embodiments, the transmission axis X1 of the polarizing layer 116 may also be parallel to the long side direction of the display panel 200.

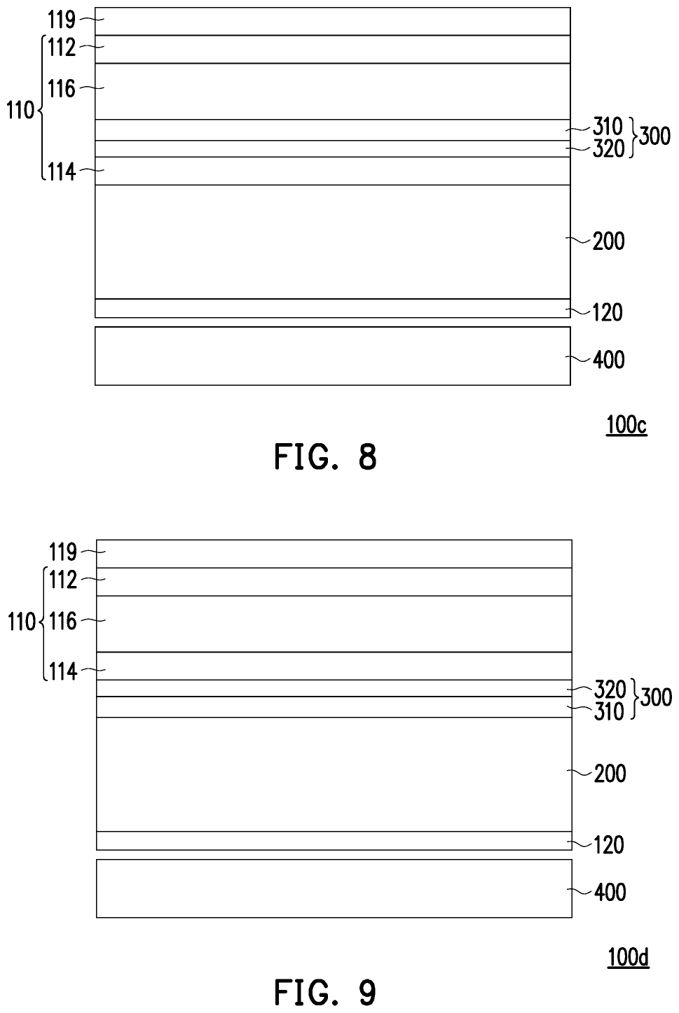

FIG. 8 is a schematic cross-sectional view of a display module according to still another embodiment of the disclosure. Referring to FIG. 8, a display module 100c of the embodiment is similar to the display module 100b of FIG. 7, and the differences between the two are as follows. In the embodiment, the image color switch film 300 is disposed between the polarizing layer 116 and the second transparent substrate 114.

FIG. 9 is a schematic cross-sectional view of a display module according to another embodiment of the disclosure. Referring to FIG. 9, a display module 100d of the embodiment is similar to the display module 100b of FIG. 7, and the differences between the two are as follows. In the embodiment, the image color switch film 300 is disposed between the second transparent substrate 114 and the display panel 200, that is, disposed between the polarizing plate 110 and the display panel 200, and the image color switch film 300 is disposed above the display panel 200.

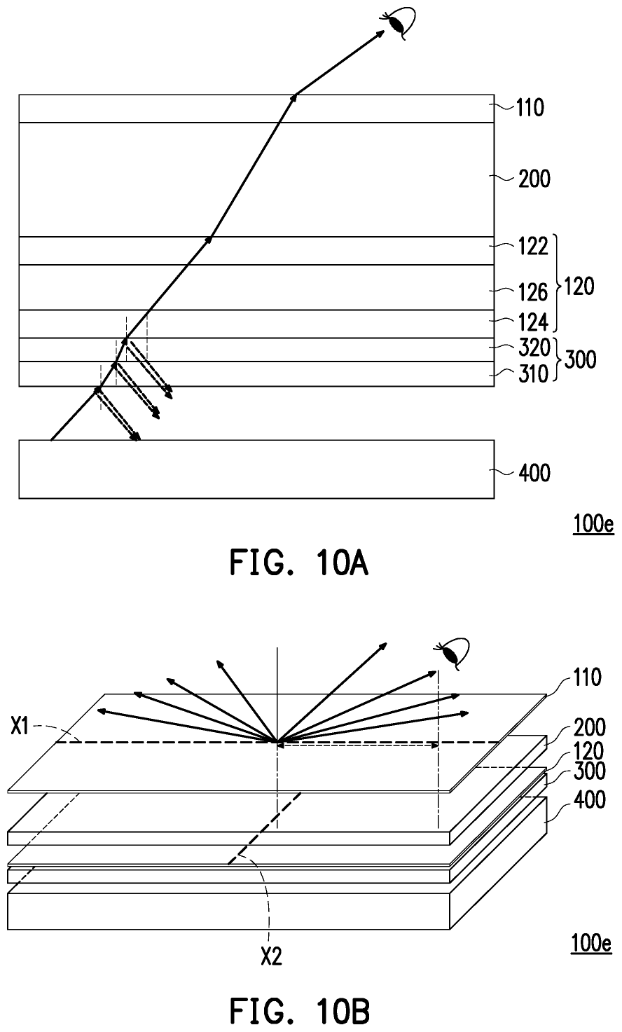

FIG. 10A is a schematic cross-sectional view of a display module according to yet another embodiment of the disclosure, and FIG. 10B is a three-dimensional layered view of the display module in FIG. 10A. Referring to FIGS. 10A and 10B, a display module 100e of the embodiment is similar to the display module 100 shown in FIGS. 1A and 1B, and the differences between the two are as follows. In the display module 100e of the embodiment, the image color switch film 300 is disposed below the display panel 200, and the polarizing plate 120 is disposed between the image color switch film 300 and the display panel 200. However, in other embodiments, the configuration may also be that the image color switch film 300 is disposed between the polarizing plate 120 and the display panel 200.

In the embodiment, the polarizing plate 120 includes a third transparent substrate 122, a fourth transparent substrate 124, and a polarizing layer 126. The third transparent substrate 122 is disposed under the display panel 200, and the third transparent substrate 122 is disposed between the display panel 200 and the fourth transparent substrate 124. The polarizing layer 126 is disposed between the third transparent substrate 122 and the fourth transparent substrate 124. The optional materials for the third transparent substrate 122 and the fourth transparent substrate 124 may be compared with the optional materials for the above-mentioned first transparent substrate 112 and the second transparent substrate 114, and the optional materials for the polarizing layer 126 may be compared with the optional materials for the above-mentioned polarizing layer 116.

In the embodiment, the transmission axis X2 of the polarizing plate 120 (i.e., the transmission axis of the polarizing layer 126) is parallel to the short side direction of the display panel 200. Therefore, for light rays with a large viewing angle in the horizontal direction, the polarizing plate 120 allows the vertically polarized light from the image color switch film 300 to pass through and blocks the parallel polarized light from the image color switch film 300. Thus, the parameters of the image color switch film 300 may be designed according to the vertically polarized light to achieve the above-mentioned optical properties. When the incident light 50 enters the polarizing plate 120 from the backlight module 400, if the incident light 50 and the reflected light 52 are set as the plane PLN (as shown in FIG. 1C), in the incident light 50, the polarized light whose polarization direction PS is perpendicular to the plane PLN may mostly pass through the polarizing plate 120, and the polarized light whose polarization direction PP is parallel to the plane PLN is absorbed by the polarizing plate 120. Therefore, the image color switch film 300 may be designed according to the vertically polarized light relative to the plane PLN, and the number of film layers may be less to be able to achieve the above-mentioned optical properties. In addition, placing the image color switch film 300 below the display panel 200 may improve the visual taste of the display module 100e because when the display module 100e does not emit light, the image color switch film 300 placed on the lower layer is less likely to reflect the external ambient light and makes the screen viewed by the user appear darker black, which enhances the visual taste.

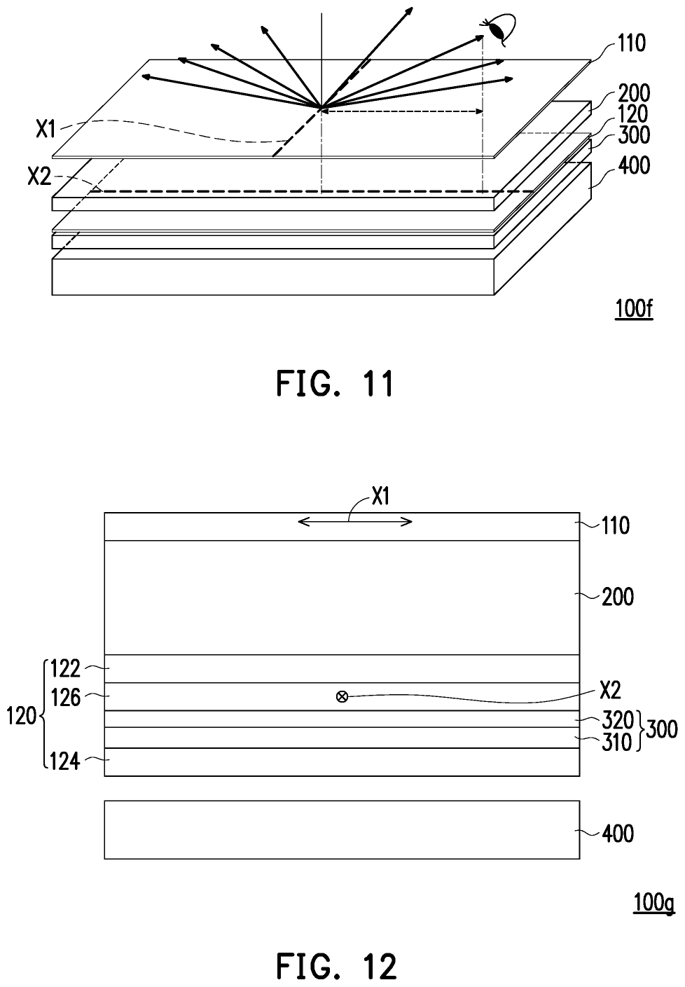

FIG. 11 is a three-dimensional layered view of a display module according to still another embodiment of the disclosure. Referring to FIG. 11, a display module 100f of the embodiment is similar to the display module 100e of FIGS. 10A and 10B, and the differences between the two are as follows. In the display module 100e shown in FIGS. 10A and 10B, the transmission axis X1 of the polarizing plate 110 is parallel to the long side direction of the display panel 200, and the transmission axis X2 of the polarizing plate 120 is parallel to the short side direction of the display panel 200. The difference from the above is that in the display module 100f of the embodiment, the transmission axis X1 of the polarizing plate 110 is parallel to the short side direction of the display panel 200, and the transmission axis X2 of the polarizing plate 120 is parallel to the long side direction of the display panel 200. In this way, at this time, the direction of the transmission axis X2 of the polarizing plate 120 is parallel to the long side direction of the display panel 200 (the long side direction is the horizontal direction). If the incident light 50 and the reflected light 52 are regarded as a plane PLN (please refer to FIG. 1C), in the incident light 50, the polarized light whose polarization direction PP is parallel to the plane PLN may mostly pass through the polarizing plate 120, and the polarized light whose polarization direction PS is perpendicular to the plane PLN is absorbed. Therefore, the image color switch film 300 may be designed according to the parallel polarized light relative to the plane PLN to achieve the above-mentioned optical properties.

FIG. 12 is a schematic cross-sectional view of a display module according to another embodiment of the disclosure. Referring to FIG. 12, a display module 100g of the embodiment is similar to the display module 100e of FIG. 10A, and the differences between the two are as follows. In the display module 100g of the embodiment, the image color switch film 300 is disposed between the third transparent substrate 122 and the fourth transparent substrate 124, and in FIG. 12 the image color switch film 300 is disposed between the polarizing layer 126 and the fourth transparent substrate 124 as an example. However, in other embodiments, the image color switch film 300 may also be disposed between the third transparent substrate 122 and the polarizing layer 126. In the embodiment, the transmission axis X2 of the polarizing layer 126 is parallel to the short side direction of the display panel 200 (i.e., the direction entering the paper surface of FIG. 12), and the transmission axis X1 of the polarizing plate 110 is parallel to the long side direction of the display panel 200 (i.e., the direction parallel to the paper surface of FIG. 12). However, in other embodiments, the transmission axis X2 of the polarizing layer 126 may also be parallel to the long side direction of the display panel 200, and the transmission axis X1 of the polarizing plate 110 is parallel to the short side direction of the display panel 200. In addition, in the embodiment, the third transparent substrate 122 may also be a retardation compensation film.

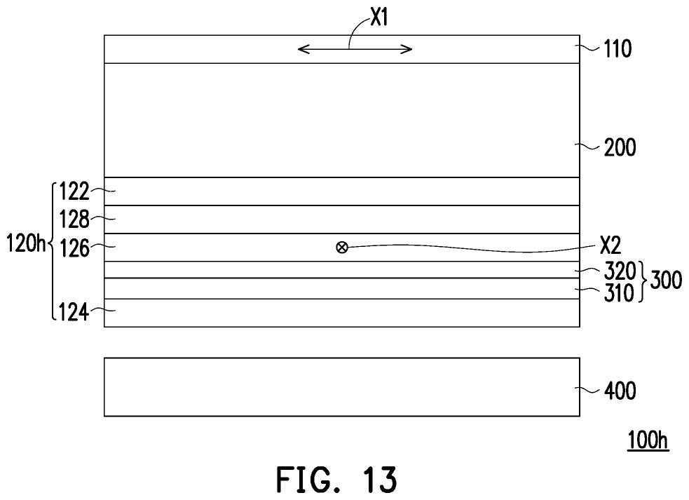

FIG. 13 is a schematic cross-sectional view of a display module according to yet another embodiment of the disclosure. Referring to FIG. 13, a display module 100h of the embodiment is similar to the display module 100g of FIG. 12, and the differences between the two are as follows. In the display module 100h of the embodiment, a polarizing plate 120h further includes a retardation compensation film 128, which is disposed between the third transparent substrate 122 and the polarizing layer 126. The functions and materials of the retardation compensation film 128 are the same as the functions and materials of the retardation compensation film 118 described above, and the descriptions are not repeated here.

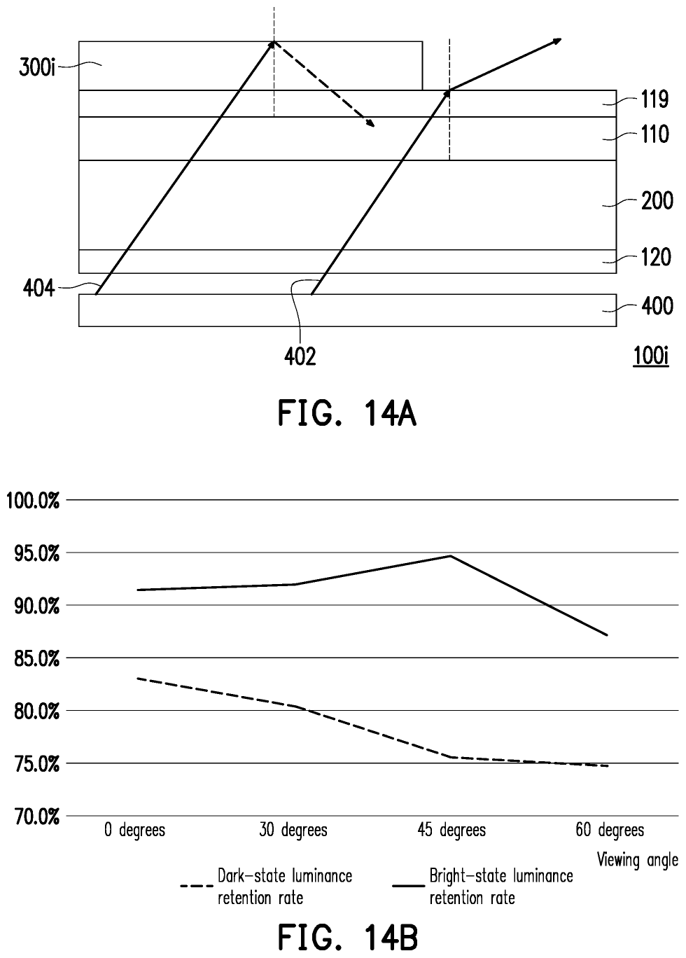

FIG. 14A is a schematic cross-sectional view of a display module according to yet another embodiment of the disclosure, and FIG. 14B is a line chart of dark-state luminance retention rates and bright-state luminance retention rates at various viewing angles of the display module in FIG. 14A using an image color switch film. Referring to FIGS. 14A and 14B, a display module 100i of the embodiment is similar to the display module 100b shown in FIG. 7, and the difference between the two is that in the display module 100i of the embodiment, an image color switch film 300i is disposed above the surface treatment layer 119, the image color switch film 300i is a single-layer light-transmitting film, and the single-layer light-transmitting film has a refractive index of 2 to 2.1, that is, the single-layer light-transmitting film has a high refractive index. In addition, the single-layer light-transmitting film is disposed on the side of the polarizing plate 110 facing away from the display panel 200. FIG. 14A shows the light path difference between the display module 100i with the image color switch film 300i and without the image color switch film 300i. In FIG. 14A, the right part of the image color switch film 300i is specifically removed to expose the surface treatment layer. 119, but actually, the image color switch film 300i of the display module 100i of the embodiment covers the entire surface treatment layer 119.

In addition, the display panel 200 is not limited to an in-plane switching liquid crystal display panel. In other embodiments, the display panel 200 may also be a vertical alignment display panel or a display panel of other liquid crystal modes.

In the use of liquid crystal displays, whether it is the in-plane switching (IPS) technology or the vertical alignment (VA) technology, it is hoped that the light leakage in the dark state (under the black screen with the backlight module 400 fully turned on) should be as low as possible, so that the contrast may be improved. When observing the light distribution in the dark state of the display, in practice, it is desirable to reduce the oblique incident/exit stray light, so as to prevent the stray light from escaping from the absorption of the polarizing layer and causing upward light leakage.

The design of the above-mentioned single-layer light-transmitting film is used for light transmitting, and a layer of a high refractive index is added to the outermost layer of the above polarizing plate 110 (i.e., the image color switch film 300i, whose refractive index is greater than the refractive index of the surface treatment layer 119, that is, the refractive index of the image color switch film 300i is, for example, greater than 1.5). When the light signal enters the air layer after passing through the surface treatment layer 119 and the high refractive index layer, since the refractive index of the image color switch film 300i is greater than the refractive index of the air layer, and light with an incident angle that is too large (for example, greater than the critical angle) is to be reflected (for example, total reflection) back to the surface treatment layer 119, the ratio of stray light exit is reduced, and the brightness of the dark state is therefore reduced. In an embodiment, the refractive index of the image color switch film 300i is 2 to 2.1, that is, the image color switch film 300i has a relatively high refractive index. In this way, the incident angle of stray light is more likely to be greater than the critical angle, so that the stray light is totally reflected back to the surface treatment layer 119.

Of course, when using this high refractive index layer, the signal light in the bright state may also be degraded due to the total reflection effect of the high refractive index, resulting in loss of brightness in the bright state. However, according to the experimental and measurement results, it may be found that the stray light ratio of the light leakage in the dark state (full black screen) is higher than the stray light ratio of the signal light in the bright state (full white screen). Therefore, the reduction ratio of light leakage in the dark state by using this high refractive index layer is higher than the reduction ratio of brightness in the bright state, so the contrast can be improved.

Therefore, the method of using the total reflection effect to reduce the stray light at a large viewing angle and improve the contrast may be applied to the outermost layer of the above polarizing plate 110. Within the viewing angle of 60 degrees, such a trend is clear, which facilitates the removal of stray light in the dark state, and may directly improve the contrast. When stray light 402 exiting at a large angle is set at the original incident angle, the stray light 402 may pass through the surface treatment layer 119 to form light leakage, as shown in FIG. 14A. However, when the critical angle of stray light 404 exiting at a large angle becomes smaller due to the high refractive index of the high-refractive material layer (i.e., the image color switch film 300i), the stray light 404 that would originally pass through the surface treatment layer 119 enters the surface treatment layer 119 and the display panel 200 again due to occurrence of total reflective and dissipates. In theory, the high refractive index material layer only needs to have a higher refractive index than the refractive index of the surface treatment layer 119. In practice, it is expected that the higher the refractive index, the better, for example, 2 to 2.1.

Table 2 below lists the dark-state luminance retention rate and the bright-state luminance retention rate of the display module 100i using the image color switch film 300i at various viewing angles.

TABLE 2

| Viewing | Dark-state luminance | Bright-state luminance |
|---|---|---|
| angle | retention rate | retention rate |
| 0 degrees | 82.9% | 91.3% |
| 30 degrees | 80.3% | 91.8% |
| 45 degrees | 75.5% | 94.5% |
| 60 degrees | 74.7% | 87.1% |

It may be seen from Table 2 and FIG. 14B that after using the image color switch film 300i, the ratio of brightness decrease in the dark state is higher than the ratio of brightness decrease in the bright state. The combined effects of dark and bright states amount to improved contrast. In the experiment shown in Table 2, the refractive index of the image color switch film 300i is set at about 2 to 2.1, the film thickness is about 5 nm to 20 nm, and the haze of the surface treatment layer 119 is 25%.

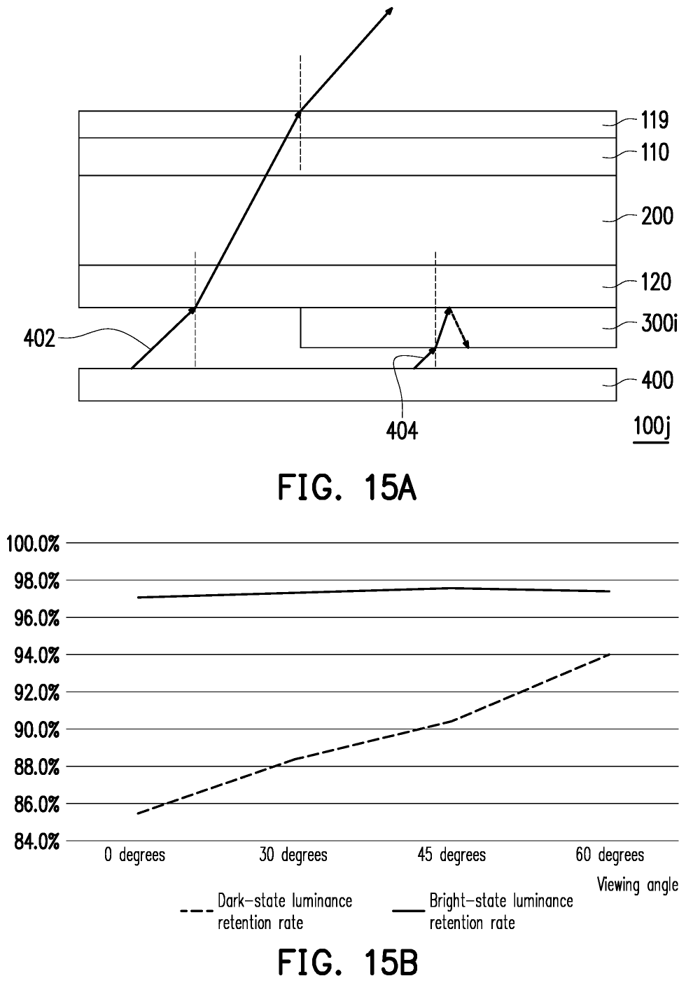

FIG. 15A is a schematic cross-sectional view of a display module according to another embodiment of the disclosure, and FIG. 15B is a line chart of dark-state luminance retention rates and bright-state luminance retention rates at various viewing angles of the display module in FIG. 15A using an image color switch film. Referring to FIGS. 15A and 15B, a display module 100j of the embodiment is similar to the display module 100i of FIG. 14A, and the difference between the two is that in the display module 100j of the embodiment, the image color switch film 300i is disposed under the polarizing plate 120 below, that is, disposed on the side of the polarizing plate 120 facing away from the display panel 200. In FIG. 15A, in order to show the difference in the light path of the display module 100j with and without the image color adjustment film 300i, in FIG. 15A, the left part of the image color switch film 300i is specifically removed to expose part of the lower surface of the polarizing plate 120. However, in fact, the image color switch film 300i of the display module 100j of the embodiment covers the entire lower surface of the polarizing plate 120.

As shown in FIG. 15A, the original oblique stray light 402 may exit the display panel 200 and the surface treatment layer 119, resulting in a decrease in contrast. Therefore, in the embodiment, a high refractive material layer (i.e., the image color switch film 300i) is added to the outermost layer of the polarizing plate 120 below (i.e., below the polarizing plate 120), since an interface between a high refractive index layer and a low refractive index layer (i.e., the polarizing plate 120) is generated, the incident angle of the stray light 404 is greater than the critical angle and total reflection occurs, so as to reflect the stray light 404 back to the backlight module 400, and there is also a mechanism to reduce or filter the stray light.

In theory, the high refractive index material layer (i.e., the image color switch film 300i) only needs to have a higher refractive index than the refractive index of the outer substrate of the polarizing plate 120. In practice, it is expected that the higher the refractive index of the image color switch film 300i, the better.

Table 3 below lists the dark-state luminance retention rate and the bright-state luminance retention rate of the display module 100j using the image color switch film 300i at various viewing angles.

TABLE 3

| Viewing | Dark-state luminance | Bright-state luminance |
|---|---|---|
| angle | retention rate | retention rate |
| 0 degrees | 85.5% | 97.2% |
| 30 degrees | 88.4% | 97.5% |
| 45 degrees | 90.4% | 97.7% |
| 60 degrees | 94.0% | 97.5% |

In the experiments in Table 3, the refractive index of the high refractive index material (i.e., the image color switch film 300i) is set at about 2 to 2.1, and the film thickness of the image color switch film 300i is about 5 nm to 20 nm, and there is no surface treatment. From Table 3 and FIG. 15B, it may be found that in the case of small viewing angles (such as 0 degrees and 30 degrees), the dark-state luminance retention rate is significantly reduced, which may effectively improve the contrast of the front viewing angle. Furthermore, from Table 3 and FIG. 15B, it may further be found that after using the image color switch film 300i, the ratio of brightness decrease in the dark state is higher than the ratio of brightness decrease in the bright state. The combined effects of dark and bright states amount to improved contrast.

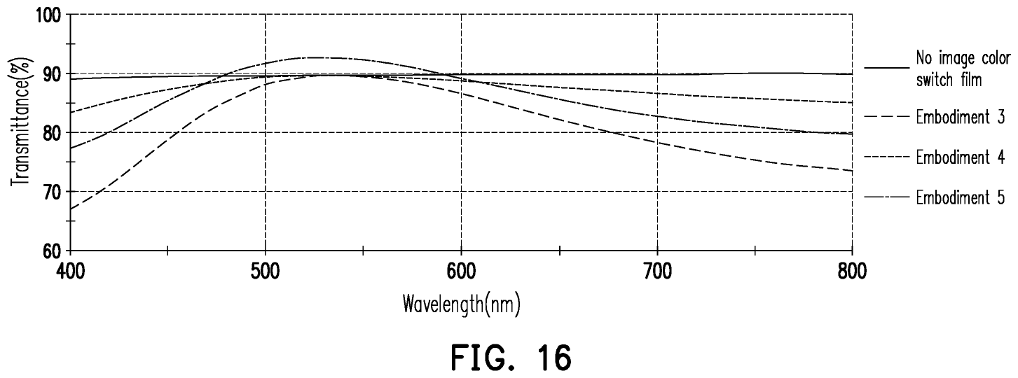

FIG. 16 is the transmittance spectrum diagram of three embodiments of the image color switch film of FIG. 1A, FIG. 14A or FIG. 15A when the viewing angle is 0 degrees, and the transmittance spectrum diagram when there is no image color switch film and when the viewing angle is 0 degrees. Referring to FIG. 16, under the front viewing angle (i.e., the viewing angle is 0 degrees, and in another embodiment, the viewing angle is within plus or minus 30 degrees), the peak of the transmittance spectrum of the image color switch film 300i or 300 falls within the range of 400 nm to 600 nm, and the average transmittance of the transmittance spectrum within the range of 500 nm to 600 nm is greater than the average transmittance of the transmittance spectrum within the range of 650 nm to 800 nm (as shown in Embodiments 3, 4, and 5 in FIG. 16). In addition to eliminating or suppressing the leakage light of long-wave red light in the dark state of the in-plane switching liquid crystal display panel at the front viewing angle, the peak falling within the range of 500 nm to 600 nm impairs less the bright state transmittance of the display module 100i, 100j or 100.

In addition, in the embodiment, under the front viewing angle (i.e., the viewing angle is 0 degrees, and in another embodiment, the viewing angle is within plus or minus 30 degrees) and in the wavelength band at 700 nm and above, the transmittance of the display module 100i, 100j or 100 is smaller than the transmittance of the display module 100i, 100j or 100 after the image color switch film 300i or 300 is removed, as shown in Embodiments 3, 4, and 5 of FIG. 16. In addition, in the embodiment, the image color switch film may be a single-layer film (such as the image color switch film 300i) or a multi-layer film (such as the image color switch film 300).

In summary, in the display module of the embodiment of the disclosure, the image color switch film is used, and in a viewing angle at least in the range of 45 degrees to 85 degrees, the peak of the transmittance spectrum falls within the range of 400 nm to 600 nm or under the front viewing angle, the peak of transmittance spectrum falls within the range of 400 nm to 600 nm, so that the image color switch film may treat different colors of light from the display panel differently. Therefore, the display module of the embodiment of the disclosure can effectively improve the contrast of various viewing angles, and in the image screen of a large viewing angle, can strengthen the blue light band and suppress the red light band or the visible light band with a wavelength greater than or equal to 580 nm, thereby improving the shortcomings of yellowish and orange-red image screens of large viewing angles.

What is claimed is:

1. A display module, comprising:
a display panel; and
an image color switch film, disposed above or below the display panel, wherein in a viewing angle at least in a range of 45 degrees to 85 degrees, a peak of a transmittance spectrum of the image color switch film falls within a range of 400 nanometers (nm) to 600 nm, and an average transmittance of the transmittance spectrum within a range of 450 nm to 600 nm is greater than an average transmittance of the transmittance spectrum within a range of 650 nm to 800 nm.

2. The display module according to claim 1, wherein the display panel is an in-plane switching liquid crystal display panel.

3. The display module according to claim 1, wherein spectrum intensity of the transmittance spectrum decreases from the peak to a long wavelength end of the transmittance spectrum.

4. The display module according to claim 1, wherein the image color switch film comprises at least one layer of interference thin film.

5. The display module according to claim 4, wherein the at least one layer of interference thin film comprises:
a first light-transmitting film; and
a second light-transmitting film, stacked with the first light-transmitting film, wherein a refractive index of the first light-transmitting film is smaller than a refractive index of the second light-transmitting film.

6. The display module according to claim 5, wherein the refractive index of the first light-transmitting film is 1.2 to 1.6, and the refractive index of the second light-transmitting film is 1.7 to 2.4.

7. The display module according to claim 5, further comprising: a first polarizing plate, disposed between the image color switch film and the display panel, wherein the image color switch film is disposed above the display panel.

8. The display module according to claim 7, wherein the first polarizing plate comprises:
a first transparent substrate, disposed between the image color switch film and the display panel;
a second transparent substrate, disposed between the first transparent substrate and the display panel;
a polarizing layer, disposed between the first transparent substrate and the second transparent substrate; and
a retardation compensation film, disposed between the first transparent substrate and the second transparent substrate.

9. The display module according to claim 7, wherein the first polarizing plate comprises:
a first transparent substrate, disposed between the image color switch film and the display panel;
a second transparent substrate, disposed between the first transparent substrate and the display panel, wherein the second transparent substrate is a retardation compensation film; and
a polarizing layer, disposed between the first transparent substrate and the second transparent substrate.

10. The display module according to claim 7, wherein a transmission axis of the first polarizing plate is parallel to a short side direction or a long side direction of the display panel.

11. The display module according to claim 5, further comprising:
a first transparent substrate, wherein the image color switch film is disposed between the first transparent substrate and the display panel;
a second transparent substrate, disposed between the image color switch film and the display panel;
a polarizing layer, disposed between the image color switch film and the second transparent substrate; and
a retardation compensation film, disposed between the polarizing layer and the second transparent substrate.

12. The display module according to claim 11, wherein a transmission axis of the polarizing layer is parallel to a short side direction or a long side direction of the display panel.

13. The display module according to claim 5, further comprising:
a first transparent substrate, wherein the image color switch film is disposed between the first transparent substrate and the display panel;
a second transparent substrate, disposed between the image color switch film and the display panel; and
a polarizing layer, wherein the image color switch film is disposed between the polarizing layer and the second transparent substrate.

14. The display module according to claim 5, further comprising: a first polarizing plate, wherein the image color switch film is disposed between the first polarizing plate and the display panel, and the image color switch film is disposed above the display panel.

15. The display module according to claim 5, further comprising:
a first transparent substrate, wherein the image color switch film is disposed between the first transparent substrate and the display panel;
a second transparent substrate, disposed between the image color switch film and the display panel, wherein the second transparent substrate is a retardation compensation film; and
a polarizing layer, disposed between the image color switch film and the second transparent substrate.

16. The display module according to claim 4, wherein the at least one layer of interference thin film is a light-transmitting film of a single layer, and a refractive index of the light-transmitting film is 2 to 2.1, the display module further comprises a first polarizing plate and a second polarizing plate, the display panel is disposed between the first polarizing plate and the second polarizing plate, and the light-transmitting film is disposed on a side of the first polarizing plate facing away from the display panel or a side of the second polarizing plate facing away from the display panel.

17. The display module according to claim 5, further comprising: a second polarizing plate, wherein the second polarizing plate is disposed between the image color switch film and the display panel, or the image color switch film is disposed between the second polarizing plate and the display panel, wherein the image color switch film is disposed below the display panel.

18. The display module according to claim 17, wherein a transmission axis of the second polarizing plate is parallel to a short side direction or a long side direction of the display panel.

19. The display module according to claim 5, further comprising:
a third transparent substrate, disposed below the display panel;
a fourth transparent substrate, wherein the third transparent substrate is disposed between the display panel and the fourth transparent substrate; and
a polarizing layer, disposed between the third transparent substrate and the fourth transparent substrate, wherein the image color switch film is disposed between the third transparent substrate and the fourth transparent substrate.

20. The display module according to claim 19, wherein a transmission axis of the polarizing layer is parallel to a short side direction or a long side direction of the display panel.

21. A display module, comprising:
a display panel; and
an image color switch film, disposed above or below the display panel, wherein, under a front viewing angle, a peak of a transmittance spectrum of the image color switch film falls within a range of 400 nm to 600 nm, and an average transmittance of the transmittance spectrum within a range of 500 nm to 600 nm is greater than an average transmittance of the transmittance spectrum within a range of 650 nm to 800 nm.

22. The display module according to claim 21, wherein the display panel is an in-plane switching liquid crystal display panel.

23. The display module according to claim 21, wherein spectrum intensity of the transmittance spectrum decreases from the peak to a long wavelength end of the transmittance spectrum.

24. The display module according to claim 21, wherein the image color switch film comprises at least one layer of interference thin film.

25. The display module according to claim 24, wherein the at least one layer of interference thin film comprises:
a first light-transmitting film; and
a second light-transmitting film, stacked with the first light-transmitting film, wherein a refractive index of the first light-transmitting film is smaller than a refractive index of the second light-transmitting film.

26. The display module according to claim 25, wherein the refractive index of the first light-transmitting film is 1.2 to 1.6, and the refractive index of the second light-transmitting film is 1.7 to 2.4.

27. The display module according to claim 24, wherein the at least one layer of interference thin film is a light-transmitting film of a single layer, and a refractive index of the light-transmitting film is 2 to 2.1, the display module further comprises a first polarizing plate and a second polarizing plate, the display panel is disposed between the first polarizing plate and the second polarizing plate, and the light-transmitting film is disposed on a side of the first polarizing plate facing away from the display panel or a side of the second polarizing plate facing away from the display panel.

28. The display module according to claim 21, wherein, under the front viewing angle and in a wavelength band at 700 nm and above, a transmittance of the display module is smaller than a transmittance of the display module after the image color switch film is removed.
